(19) United States
(12) Patent Application Publication
(10) Pub. No.: US 2025/0254301 A1
(43) Pub. Date: Aug. 7, 2025

(54) GEOMETRIC PARTITION MODE IN VIDEO CODING

(71) Applicant: DOLBY LABORATORIES LICENSING CORPORATION, San Francisco, CA (US)

(72) Inventors: Ashwin Natesan, Bangalore (IN); Jay Nitin Shingala, Bangalore (IN); Jeeva Raj Arumugam, Rasipuram (IN); Manasi Mahendra Remane, Pune (IN); Vaibhav Pandurang Valvaiker, Bangalore (IN); Taoran Lu, Santa Clara, CA (US); Fangjun Pu, Sunnyvale, CA (US); Peng Yin, Ithaca, NY (US)

(73) Assignee: DOLBY LABORATORIES LICENSING CORPORATION, San Francisco, CA (US)

(21) Appl. No.: 18/856,049

(22) PCT Filed: Apr. 5, 2023
(86) PCT No.: PCT/US2023/017541

§ 371 Date: Oct. 10, 2024

(30) Foreign Application Priority Data
Apr. 12, 2022 (IN) 202241021947
Jul. 4, 2022 (IN) 202241038441

(51) Int. Cl. H04N 19/119; H04N 19/11; H04N 19/70; H04N 19/88

(52) U.S. Cl. CPC H04N 19/119; H04N 19/11; H04N 19/70; H04N 19/88

(57) ABSTRACT

Methods related to the geometric partition mode (GPM) in video coding are described. The proposed methods include: applying adaptive ordering of merge candidates with template matching (ARMC-TM) to derive GPM inter candidate lists, candidates list applying merge motion vector differences in GPM, enabling GPM for all-intra coding units (CUs), using inter and intra template costs in intra-prediction modes of GPM, using GPM partitions to generate templates in template matching, and using neighboring reconstructed samples and an edge criterion to derive top and left-edge intercepts to generate partitioning candidates.

### CROSS-REFERENCE TO RELATED APPLICATIONS

This application claims priority of Indian Provisional Patent Application No. 202241021947 filed Apr. 12, 2022 and Indian Provisional Patent Application No. 202241038441 filed Jul. 4, 2022, each of which is incorporated by reference in its entirety. TECHNOLOGY

The present document relates generally to images and video coding. More particularly, an embodiment of the present invention relates to applications of geometric partitioning mode (GPM) in video coding.

### BACKGROUND

In 2020, the MPEG group in the International Standardization Organization (ISO), jointly with the International Telecommunications Union (ITU), released the first version of the Versatile Video Coding Standard (VVC), also known as H.266 (Ref. [1]). More recently, the same group has been working on the development of the next generation coding standard that provides improved coding performance over existing video coding technologies. As part of this investigation, new coding techniques are also examined.

As appreciated by the inventors here, improved techniques for applying geometric partitioning mode (GPM) in image and video coding are desired, and they are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts examples of geometric partitioning mode (GPM) splits in video coding, grouped for specific angles but varying offsets;

FIGS. 2A-2D depict example processes for applying adaptive reordering of merge candidates (ARMC) in GPM processing according to embodiments of this invention;

FIG. 3 depicts an example of a coded unit split using GPM with associated templates according to an embodiment of this invention;

FIG. 4 depicts an example process flow for intra-prediction mode (IPM) list vs GPM inter candidate list re-ordering according to embodiments of this invention;

FIG. 5 depicts an example of a coding unit and partition-related parameters according to an embodiment of this invention;

FIG. 6 depicts examples of Intra candidates for geometric partition generated according to an embodiment of this invention; and

FIG. 7 depicts an example process to generate Intra candidates for geometric partition according to an embodiment of this invention.

### DESCRIPTION OF EXAMPLE EMBODIMENTS

Example embodiments that relate to applying geometric partitioning mode in video coding are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to applications of the geometric partitioning mode in image and video coding. Example embodiments include: applying adaptive ordering of merge candidates with template matching (ARMC-TM) to derive GPM inter candidate lists, applying merge motion vector differences in GPM, enabling GPM for all-intra coding units (CUs), using inter and intra template costs in intra-prediction modes of GPM, using GPM partitions to generate templates in template matching, and using neighboring reconstructed samples and an edge criterion to derive top and left-edge intercepts to generate partitioning candidates.

### Geometric Partitioning Mode in Video Coding

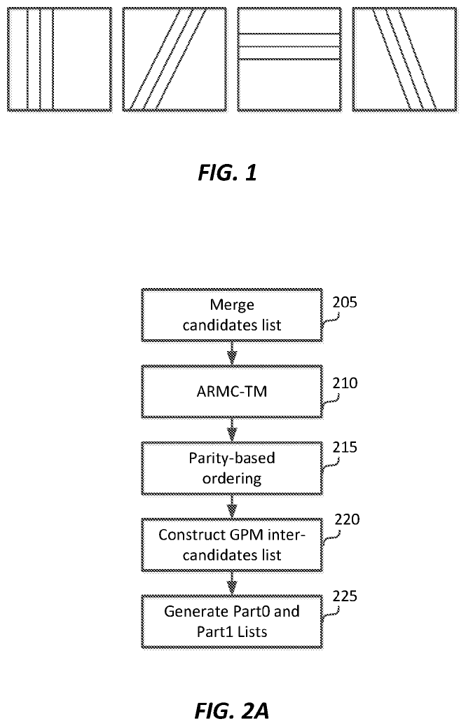

FIG. 1 depicts examples of geometric partitioning mode (GPM) in video coding (Ref. [1]). Geometric Partitioning Mode is an inter prediction tool wherein a coding unit (CU) can be partitioned into two by a line parametrized by an angle (P and a distance p. GPM provides the capability to predict arbitrary object boundaries without resorting to smaller CUs.

In VVC (Ref. [1]), the geometric partitioning mode is signaled using a CU-level flag as one kind of a merge mode, with other merge modes including: the regular merge mode, the merge with motion vector differences (MMVD) mode, the combined intra and inter prediction (CIIP) mode, and the subblock merge mode. In total, 64 partitions are supported by geometric partitioning mode for each possible CU of size W×H=2^{m}×2ⁿ with m, n∈{3•••6}, excluding 8×64 and 64×8, where W denotes width and H denotes height in pixels.

When this mode is used, a CU is split into two parts by a geometrically located straight line. The location of the splitting line is mathematically derived from the angle and offset parameters of a specific partition. Each part of a geometric partition in the CU is inter-predicted using its own motion. Only single-prediction is allowed for each partition, that is, each part has one motion vector and one reference index. The single-prediction motion constraint is applied to ensure that as in conventional bi-prediction, only two motion compensated predictions are needed for each CU.

If geometric partitioning mode is used for the current CU, then a geometric partition index indicating the partition mode of the geometric partition (angle and offset), and two merge indices (one for each partition) are further signaled. The number of maximum GPM candidate sizes is signaled explicitly in the sequence parameter set (SPS) and specifies syntax binarization for GPM merge indices. After predicting each of part of the geometric partition, the sample values along the geometric partition edge are adjusted using a blending processing with adaptive weights. This is the prediction signal for the whole CU. Transform and quantization processes will be applied to the whole CU as in other prediction modes. Finally, the motion field of a CU predicted using the geometric partition modes is stored, with some modifications to handle motion vector (MV) mixing at the partition boundary.

In recent developments in JVET on the enhanced compression model (ECM v.4.0), three GPM improvements are included:
1) GPM with merge motion vector differences (GPM-MMVD) (Ref. [2]), where GPM in VVC is extended by applying motion vector refinement on top of the existing GPM single-directional MVs. A flag is first signaled for a GPM CU, to specify whether this mode is used. If the mode is used, each geometric partition of a GPM CU can further decide whether to signal motion vector difference (MVD) or not. If MVD is signaled for a geometric partition, after a GPM merge candidate is selected, the motion of the partition is further refined.
2) GPM with template matching (GPM-TM) (Ref. [3]), where when GPM mode is enabled for a CU, a CU-level flag is signaled to indicate whether template matching (TM) is applied to both geometric partitions. Motion information for each geometric partition is refined using TM. When TM is chosen, a template is constructed using left, above, or left and above, neighboring samples according to the partition angle. The motion is then refined by minimizing the difference between the current template and the template in the reference picture using the same search pattern of merge mode with half-pel interpolation filter disabled.
3) GPM with inter and intra prediction (Ref. [4]), where in GPM with inter and intra prediction, the final prediction samples are generated by weighting inter predicted samples and intra predicted samples for each GPM-separated region. The inter predicted samples are derived by the same scheme as the GPM in ECM, whereas the intra predicted samples are derived by an intra prediction mode (IPM) candidate list and an index signaled from the encoder. The IPM list is filled with parallel mode, then candidates from templated based intra mode derivation (TIMD), decoder side intra mode derivation (DIMD), and neighboring blocks. The size of this list is 3.

In analyzing the complexity of existing GPM-related techniques, the following observations can be made:
The memory required to store all the necessary look-up tables (LUTs) used for computing blending weights and motion vector (MV) storage types is large.
GPM with inter and intra prediction and GPM-TM introduce a spatial dependency during the prediction computation stage in the decoding pipeline.
The complexities of GPM-TM, and TIMD when used by GPM with inter and intra prediction, are very high. This will introduce significant latency in multiple stages of the decoding pipeline, including motion vector predictor (MVPred) computation, and boundary strength (BS) calculation. One obvious consequence is that motion vector predictor (MVPred) and most probable mode (MPM) computation of subsequent virtual pipeline data units (VPDUs) will be blocked until TM and/or TIMD finish their processing.
GPM-TM requires reconstruction of the spatial neighbors to be converted back from reshaped domain when the luma-mapping, chroma scaling (LMCS) tool in VVC is enabled.

Embodiments presented here aim at improving the GPM process from different aspects:
1) Proposals for quality improvement (QI): Aiming at improving compression efficiency, preferably without any additional hardware (HW) implementation issues as compared to current coding tools.
2) Proposals to get rid of HW dependency/pipeline issues (HWPI) and for hardware/software (HW/SW) complexity reduction (CR): Aiming at solving the HW dependency/pipeline issues and harmonization of similar tools by considering certain guidelines, and HW/SW friendly solutions like complexity reduction with minimal impact on compression efficiency.

### Adaptive Reordering of Merge Candidates (ARMC) for Deriving GPM Inter Candidate List

Motivation: In ECM 4.0, adaptive re-ordering of merge candidates with template matching (TM) (ARMC-TM) (Ref. [6]) is enabled. After a merge candidate list is constructed, merge candidates are divided into several subgroups. Merge candidates in each subgroup are reordered ascendingly according to cost values based on template matching. ARMC-TM is not applied for merge list construction used in GPM inter candidate list derivation. Using ARMC-TM in inter candidate derivation will improve the efficiency of GPM due to reduced merge index signaling cost.

### Proposals:

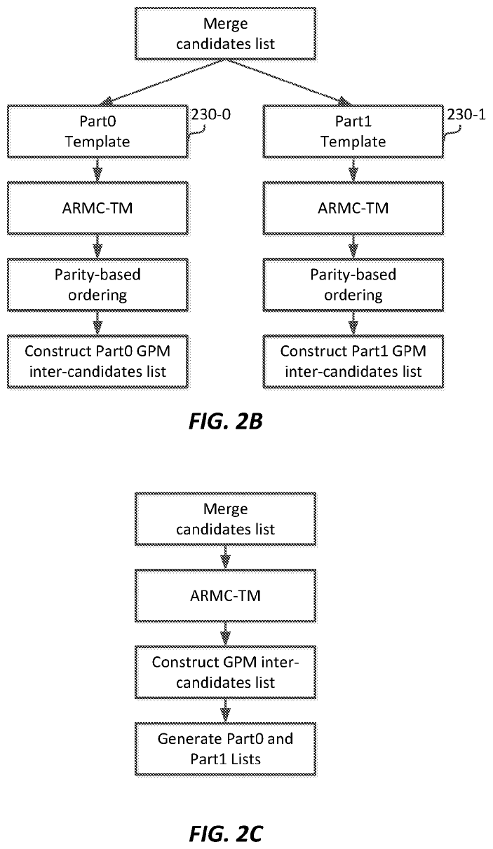

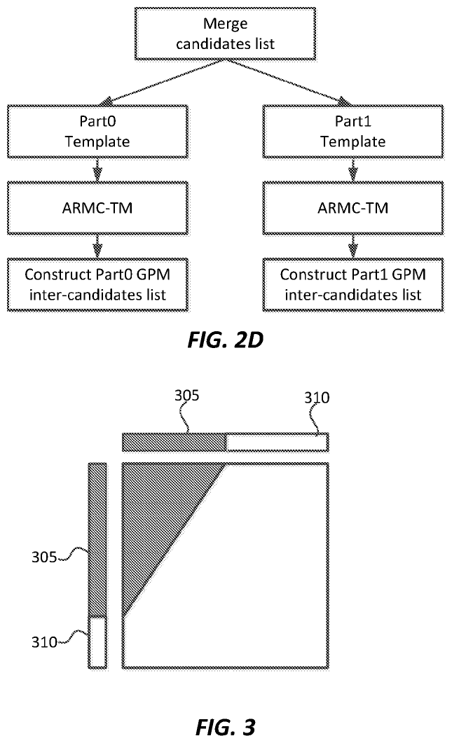

1) Use ARMC-TM to the inter merge candidate list before constructing GPM inter candidate list. The GPM list construction process based on merge index parity will remain unaltered and will be applied for re-ordering the merge candidate list. An example process according to an embodiment is depicted in FIG. 2A. In FIG. 2A and subsequent discussions, Part0 and Part1 denote the two partitions in a CU with GPM mode, where each partition has its own merge candidate list. As depicted in FIG. 2A, ARMC-TM (210) follows the merging of the candidates list (205). Next, the output of ARMC-TM is followed by parity based ordering (215). The parity based re-ordering ensures L0 and L1 references get equal priority with regards to their position in the list. Without ARMC-TM, the list will be ordered based on spatial and temporal proximity of neighbor CU, and hence parity based re-ordering will choose the top candidates based on proximity. Applying parity based re-ordering after ARMC-TM ensures that L0 and L1 candidates are prioritized based on their template costs instead of their spatial or temporal proximity. Next, in step 220 one constructs the inter-candidate list, and finally, in step 225, the Part0 and Part1 lists are generated.
2) Use a mechanism identical to (1), except create separate lists for both partitions and use partition dependent templates when using ARMC-TM for re-ordering. An example process according to an embodiment is depicted in FIG. 2B. Compared to FIG. 2A, after the merge candidates list step (205), two separate templates (230-0 and 230-1) are created, and then, in each path, the process continues as in FIG. 2A.
3) Use ARMC-TM to generate the inter merge candidate list before constructing the GPM inter candidate list. Set the GPM inter candidate list identical to the inter merge candidate list. The GPM list construction process based on merge index parity will not be applied for re-ordering the merge candidate list. As explained earlier, the parity based re-ordering ensures L0 and L1 references get equal priority with regards to their position in the list. Without ARMC-TM, the list will be ordered based on spatial and temporal proximity of neighbor CU, and hence parity based re-ordering will choose the top candidates based on proximity. But, using ARMC-TM ensures that the lists are already prioritized based on their template costs instead of their spatial or temporal proximity, and hence parity based re-ordering may be unnecessary. An example process according to an embodiment is depicted in FIG. 2C, where compared to FIG. 2A, the parity-based ordering (215) has been eliminated.
4) Use a mechanism identical to (3), except create separate lists for both partitions and use partition dependent templates when using ARMC-TM for re-ordering. An example process according to an embodiment is depicted in FIG. 2D. This is similar to FIG. 2B, but again, the parity based ordering (215) has been eliminated.
5) Use ARMC-TM-like algorithm to re-order GPM inter candidate list. The GPM inter candidate list will be derived from the inter merge candidate list. The GPM list construction process based on merge index parity will be replaced by an ARMC-TM-like mechanism.

### MMVD-TM for GPM-MMVD

Motivation: Ref. [5] introduced TM reordering for merge motion vector differences (MMVD) refinement positions. Using the same in GPM will improve quality due to reduced MMVD index signaling cost.

### Proposals:

1) Use template matching (TM) for re-ordering MMVD indexes used in GPM-MMVD.
2) Use partition based templates for re-ordering MMVD indices used for each partition.
   Enabling GPM for all-Intra CU's

Motivation: Ref. [4] prohibits GPM CUs with both partitions coded as intra in order to reduce the signalling overhead for Intra prediction modes (IPMs) and avoid an increase in the size of the intra prediction circuit on the hardware decoder. As appreciated by the inventors, the latter concern incorrect because the TIMD/DIMD intra prediction circuit can be reused.

### Proposals:

1) Mark GPM CUs with both partitions coded as intra CUs. For such CUs, the intra modes for each partition, derived from the IPM list, are signaled via the respective IPM indices instead of GPM_MAX_NUM_UNI_CANDS plus the IPM index. Another advantage of this proposal is that GPM can be enabled in I slices as well.
   a. In an example embodiment, one can signal two sets of syntax elements in the bitstream
      i. spsiafintra(pmenabledflag—To be signaled in the SPS
      ii. CU level syntax elements to be signaled as part of the coding unit (CU).
         Table 1 depicts an example of such signaling. Compared to the existing ECM syntax, new syntax is indicated by an Italic font. This implementation assumes mutually exclusive signaling for GPM intra with MIP (Matrix-based intra prediction), ISP (Intra subblock partitioning) and MRL (Multiple reference line intra prediction). In other embodiments these modes may be enabled simultaneously, at the expense of increased complexity.

TABLE 1
Example syntax for GPM in Intra prediction mode (IPM)

| | |
|---|---|
| if( sps_mip_enabled_flag ) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_mrl_enabled_flag && ( ( y0 % CtbSizeY ) > 0 ) ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) && | |
| ( cbWidth * cbHeight > MinTbSizeY * MinTbSizeY ) && | |
| !cu_act_enabled_flag ) | |
| intra_subpartitions_mode_flag | ae(v) |
| if( intra_subpartitions_mode_flag = = 1 ) | |
| intra_subpartitions_split_flag | ae(v) |
| if( sps_allintra_gpm_enabled_flag && ! intra_subpartitions_mode_flag && | |
| intra_luma_ref_idx = = 0 ) | |
| intra_gpm_flag | ae(v) |
| if( intra_gpm_flag = = 1 ) { | |
| gpm_part_type_idx[ x0 ][ y0 ] | ae(v) |
| for( i = 0; i < 2; i++) | |
| intra_luma_ipm_idx[ x0 ][ y0 ][ i ] | ae(v) |
| } else { | |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else | |
| intra_luma_mpm_remainder[ x0 ][ y0 ] | ae(v) |
| } | |

Example syntax semantics for the proposed syntax include: intra_gpm_flag specifies whether the geometric partioning mode is applied for the current coding unit. The array indices x0, y0 specify the location (x0, y0) of the top-left luma sample of the considered coding block relative to the top-left luma sample of the picture.

gpm_part_type_idx [x0][y0] specifies the partitioning shape of the geometric partitioning mode. The array indices x0, y0 specify the location (x0, y0) of the top-left luma sample of the considered coding block relative to the top-left luma sample of the picture.

intra_luma_ipm_idx [x0][y0][0] specifies the first intra prediction mode index of the geometric partitioning based intra prediction where x0, y0 specify the location (x0, y0) of the top-left luma sample of the considered coding block relative to the top-left luma sample of the picture.

intra_luma_ipm_idx [x0][y0][1] specifies the second intra prediction mode index of the geometric partitioning based intra prediction where x0, y0 specify the location (x0, y0) of the top-left luma sample of the considered coding block relative to the top-left luma sample of the picture.
b. Based on a), to further reduce the overhead of signaling GPM intra mode, one may only signal gpm_part_type_idx, but not the IPM mode. Instead, one can use template matching to help decide the IPM mode. Basically, one extends the GPM partition line to its top and left templates and the extended line divides the left or top template into two partitions, as shown in FIG. 3. Then for each partition in the template, one can decide the best IPM mode using DIMD or TIMD, then assign the IPM to the associated GPM partition for the current CU. In another embodiment, one can use the derived IPM mode as the most probable mode (MPM) and refine the IPM based on the MPM, and only signal the remaining modes based on the MPM.
c. Based on a) one can infer gpm_part_type_idx. Method 1: For top or left template, one can use DIMD to decide what best partition is. Then, for each partition type index (idx), using DIMD in each partition, one can decide on the best IPM and the cost. Next, sum the costs of the two partitions together. The one with minimal cost decides the GPM partition type. Method 2: same as method 1, but apply TIMD instead. In another embodiment, one can use method 1 or method 2 as partition prediction, then one can refine around the prediction and only signal the difference.
   It is noted that the method in c) can be applied for inter-related GPM mode too.

### Deriving all Intra Geometric Partition Type Using Neighbor Reconstruction Sample Gradients

Motivation: For the GPM partition mode with both partitions coded as Intra, for each partition, signaling of indices is needed to specify the partition type (from Table 36 in Ref.[1], a total of 64 partition types are allowed in VVC) and the intra mode. To reduce the signaling cost, one of the approaches being used is template-based partition type and intra mode selection, where only the index corresponding to the list sorted based on template cost is signaled. Template matching uses the neighbor reconstruction samples on the decoder side to compute the cost for each combination of partition type and intra modes. This increases the complexity on the decoder, since it requires to compute the template cost for 64 partition types multiplied by the number of Intra modes for each partition. In Ref. [8], a template is used to generate a shorter candidate list. For example, in a test, only 26 out of 64 partition modes are used and only the MPMs out of 67 possible intra prediction modes are used.

Proposal: compute gradients across the horizontal and vertical axes (denoted as G(x) and G(y)) using the neighbor reconstructed pixels from above the top boundary and to the left of the left boundary of the current CU. Gradients can be computed using an appropriate set of filter coefficients, e.g., 3×3 edge-detection filters, like the Sobel filters and the like. The computed gradients are then used to derive the best partition types which are a subset of the maximum allowed partition types. For example, one may compute the points on the edges where the max of G(x) and G (y) occurs. This approach reduces the number of partition types to be evaluated for computing the template cost on the decoder side and helps to reduce the decoding complexity.

Consider FIG. 5, depicting the current CU and neighbor reconstructed samples surrounding the CU to the top and to the left. An intercept (507-a or 507-b) is the point on the edge (top or left) of the CU where an energy shift is detected using gradients. In an embodiment, the partition type which passes through this intercept has the higher chance of being selected as an all-Intra GPM partition type. Given the intercepts, corresponding angles (502-a or 502-b) are derived using the arctan(G(y)/G (x)) of the vertical and horizontal gradient values at the intercepts. The partition type using the derived angle also has the higher chance to be selected.

In an embodiment, without limitation, one may apply the following Sobel filters:

$${F}_{x} = [ \begin{matrix}- 1 & 0 & 1 \\ - 2 & 0 & 2 \\ 1 & 0 & 1\end{matrix} ] , {F}_{y} = [ \begin{matrix}- 1 & - 2 & - 1 \\ 0 & 0 & 0 \\ 1 & 2 & 1\end{matrix} ] .$$

The gradients along the x and y axis are calculated by elementwise multiplication of the Sobel filter coefficients and the reconstructed neighbor samples (NbrRecon (x,y)), where, for example, (x,y) denotes the center of the filter kernel (e.g., see the 3×3 filter in FIG. 5):

$$G ( x ) = {F}_{x} * NbrRecon ( x , y )$$

$$G ( y ) = {F}_{y} * NbrReco n ( x , y )$$

To compute the maximum gradient (or detect an edge) one can apply L1 or L2 norm calculations, such as:
L1-norm variant for edge detection metric: |G(x)|+|G(y)|
L2-norm variant for edge detection metric: \sqrt{G(x)²+G(y)²}

Based on the angle and intercept position derived for each edge intercept, next, one derives a set of reference partition modes with intercepts that are closer to the intercepts determined by the edge detection filters, and characterized by reference angle and/or position information. Then, for each reference partition mode one can derive a set of candidate partition modes as described below.

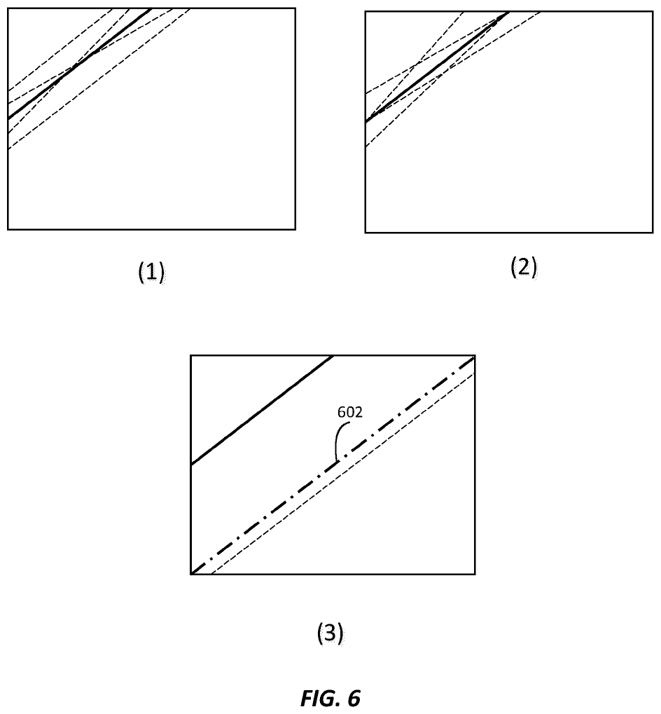

FIG. 6 depicts examples of three sets of evaluation modes to determine candidate partitions. A solid line indicates the reference partition mode and dotted lines indicates additional modes to be evaluated around the reference partition mode. The unique elements in the union of all three sets are used as the list of partitions to be evaluated. Table 2 describes all three alternative evaluation modes with example cases depicted in FIG. 6.

TABLE 2
Description of alternative partition modes available for evaluation

| Figure | |
|---|---|
| ID | Description of modes |
| 6.1 | The reference mode is the partition with intercepts that are closest to the |
| | intercepts determined by the edge detection filter (see notes below on determining |
| | the closest reference mode) |
| | The reference mode is characterised by angle and distance indices. The partitions |
| | indicated by the dotted lines are the four partitions derived by incrementing the |
| | angle and distance indices by +1 and −1 respectively |
| | For example, if the reference mode is described using the pair (α, ρ), where α is |
| | the angle index and ρ is the distance offset, the dotted lines correspond to the |
| | dotted lines corresponding to the modes that can be described via the pairs (α − 1, |
| | ρ), (α + 1, ρ), (α, ρ − 1), and (α, ρ + 1) |
| 6.2 | The reference mode is the partition with intercepts that are closest to the |
| | intercepts determined by the edge detection filter |
| | The reference mode is characterised by a pair of intercepts at the top and left |
| | boundaries. The partitions indicated by the dotted lines are the four partitions |
| | derived via incrementing the angle indices at the left and top boundaries by +1 |
| | and −1 respectively while keeping the corresponding position of the intercept |
| | constant. |
| | For example, if the reference mode is described using the pairs (α_{L}, x_{L}) and (α_{T}, |
| | x_{T}), where α is the angle index and x is the intercept position, and each pair |
| | corresponds to either the top or the left boundary, the dotted lines correspond to |
| | the modes that can be described via the pairs (α_{L} − 1, x_{L}), (α_{L} + 1, x_{L}), (α_{T} − 1, x_{T}), |
| | and (α_{T} + 1, x_{T}). |
| 6.3 | The reference mode is the partition with intercepts that are closest to the |
| | intercepts determined by the edge detection filter |
| | The reference mode is characterised by its angle (φ). The partition indicated by |
| | the dotted line is the partition corresponding to the ‘mirror’ angle and with a |
| | distance offset closest to the reference mode intercept |
| | The mirror angle is derived by adding 180° to the reference mode angle. This will |
| | result in the corresponding partition edge to drift to the opposite side of the |
| | diagonal dotted line (602) dividing the CU in half |

In an embodiment, as shown by Table 3, up to 29 possible partition modes may be generated; however, in practice, the actual number of unique available partitions is far smaller. Systems may also decide to remove certain options to reduce computational cost at the expense of reducing coding efficiency. Experiments on a million CUs yielded a median number of 14 partitions.

TABLE 3
Examples of possible partitions modes to be
evaluated using the criteria of Table 2

| Modes | Count |
|---|---|
| M1: Reference mode from joining intercepts | 1 |
| M2: Reference mode from (α_{L}, x_{L}) | 1 |
| M3: Reference mode from (α_{T}, x_{T}) | 1 |
| M4: Mirror of M2 | 1 |
| M5: Mirror of M3 | 1 |
| Use M1 to generate: | 4 |
| {(α − 1, ρ), (α + 1, ρ), (α, ρ − 1), (α, ρ + 1)} | |
| Use M2 to generate: {(α_{L} − 1, x_{L}), (α_{L} + 1, x_{L})} | 2 |
| Use M2 to generate: | 4 |
| {(α − 1, ρ), (α + 1, ρ), (α, ρ − 1), (α, ρ + 1)} | |
| Use M3 to generate: {(α_{T} − 1, x_{T}), (α_{T} + 1, x_{T})} | 2 |
| Use M3 to generate: | 4 |
| {(α − 1, ρ), (α + 1, ρ), (α, ρ − 1), (α, ρ + 1)} | |
| Use M4 to generate: | 4 |
| {(α − 1, ρ), (α + 1, ρ), (α, ρ − 1), (α, ρ + 1)} | |
| Use M5 to generate: | 4 |
| {(α − 1, ρ), (α + 1, ρ), (α, ρ − 1), (α, ρ + 1)} | |
| Total | 29 |

Note that given mode M2, {(α_{L}−1, x_{L}), (α_{L}+1, x_{L})} is potentially a different set of modes from {(α−1, φ, (α+1, ρ)} since the former uses the intercept to characterize the modes, whereas the latter uses the distance index distanceIdx. The same applies to mode M3 as well. The operation “mirror” denotes the mirror operation under the 6.3 criterion described in Table 2.

For a given CU size and for any of the 64 partitions one can derive the position parameters of the top and left intercepts using equations in section 8.5.7.2 in Ref. [1]. For the intercepts generated by the edge detector, one can and compute their distance from the 64 available and select the one with the smallest distance (e.g., an L1 or L2 distance). For example, if S describes an intercept for a partition from Ref.[1], and F describes an intercept generated by the edge detector, one may select the mode which minimises their L1 distance |S.left−F.left|+|S.top−F.top|. Note that not all 64 modes have both a left and a top intercept. In cases where only one of the two intercepts are available, one may use the equations in section 8.5.7.2 to derive intercepts for all modes computed based on the angle output generated by the edge detector, and then select the mode with an intercept closest to one of the outputs by the edge detector.

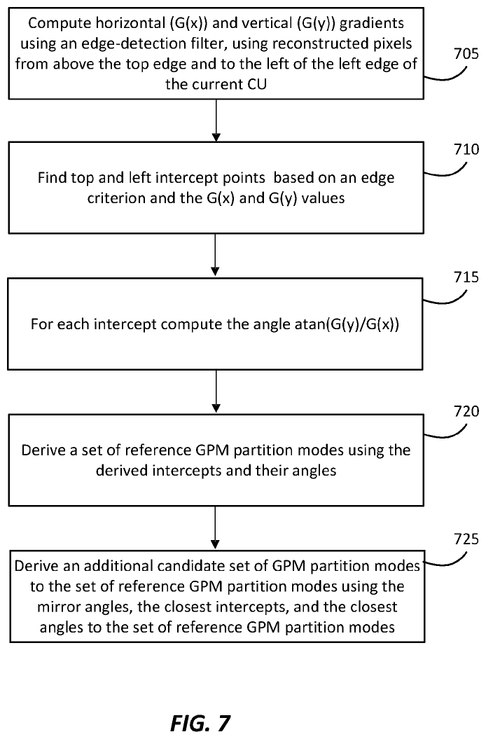

An example embodiment of the whole process is summarized in FIG. 7.
Step 705: Compute horizontal (G(x)) and vertical (G(y)) gradients using an edge-detection filter, using reconstructed pixels from above the top edge and to the left of the left edge of the current CU
Step 710: Find top (x_{T}) and left intercept (x_{L}) points based on an edge criterion (e.g., L1 or L2 norms described earlier) and the corresponding G(x) and G(y) values
Step 715: For each intercept compute the angle atan(G(y)/G(x)), for the x, y values of the filter at the intercept, say α_{L} for the left intercept and (α_{T} for the top intercept
Step 720: Derive a set of reference GPM partition modes using the derived intercepts and their angles (e.g., modes M1, M2, and M3 depicted in Table 3)
Step 725: Derive additional sets of candidate GPM partition modes using mirror angles (e.g., M4 and M5), closest intercepts, and closest angles to the set of the reference GPM partition modes (e.g., see examples in Table 3)

Table 4 provides an example of the derivation of a partition list using the techniques described Table 2 and Table 3. In Table 4, NA denotes “not available,” that is, the alternative angle index and distance values are not allowed. The partition numbers correspond to those in Table 36 of the VVC specification (Ref. [1]). For example, M1=23 corresponds to angleIdx=11 and distanceIdx=3.

TABLE 4
Example of deriving a partitioning list

| Left boundary edge detector output | (α_{L}, x_{L}) = (7, 14) |
|---|---|
| Top boundary edge detector output | (α_{T}, x_{T}) = (18, 25) |
| Reference mode from joining intercepts | M1 = 23 |
| Reference mode from (α_{L}, x_{L}) | M2 = NA |
| Reference mode from (α_{T}, x_{T}) | M3 = 38 |
| M1 => {(α − 1, ρ), (α + 1, ρ), (α, ρ − 1), (α, ρ + 1)} | {NA, 27, 22, NA} |
| M2 => {(α_{L} − 1, x_{L}), (α_{L} + 1, x_{L})} | {NA, 18} |
| M2 => {(α, ρ − 1), (α, ρ + 1)} | {19, NA} |
| M2 => mirror | M4 = 50 |
| M4 => {(α, ρ − 1), (α, ρ + 1)} | {NA, 51} |
| M3 => {(α_{T} − 1, x_{T}), (α_{T} + 1, x_{T})} | [NA, 41} |
| M3 => {(α, ρ − 1), (α, ρ + 1)} | {2, 39} |
| M3 => mirror | M5 = 5 |
| M5 => {(α, ρ − 1), (α, ρ + 1)} | {4, NA} |
| Final partition list | {2, 4, 5, 18, 19, 22, 23, 27, 38, 39, 41, 50, 51} |

Note that the final partition list in Table 4 is sorted to eliminate duplicate entries. This list, in combination with the MPM or the IPM list (see proposed embodiment next), will be sorted based on the template cost.

In an embodiment, to further improve computational efficiency, instead of using the MPM list one uses the IPM list. More specifically, the proposed approach is to use the IPM list (see Ref. [4]) with maximum of GEO_MAX_NUM_INTRA_CANDS (or any subset) modes for each partition. In the ECM software, GEO_MAX_NUM_INTRA_CANDS is a constant with a value of 3. The IPM list adds the intra mode parallel to GPM partition type, DIMD modes, TIMD modes, neighbor modes, intra mode perpendicular to GPM partition type and planar mode based on the availability. In another embodiment, one may enforce that the planar and DC modes are always in the IPM list.

### IPM List Vs GPM Inter Candidate List Re-Ordering

Motivation: When one of the partitions in GPM is intra coded, the corresponding mode is signaled using the value GPM_MAX_NUM_UNI_CANDS and IPM index (Ref. [4]). Intra partitions would thus incur a large cost for signaling their mode. This proposal defines mechanisms for minimizing this cost.

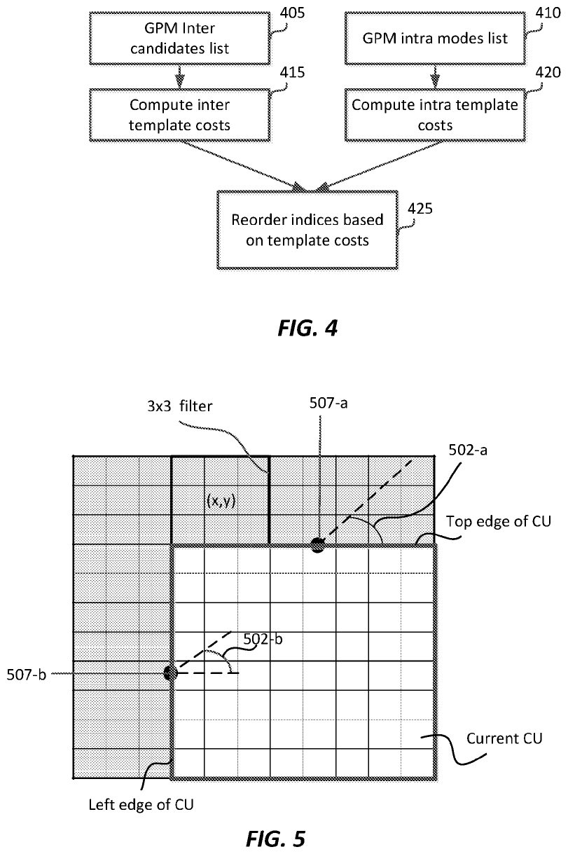

Proposal: FIG. 4 depicts an example process of an embodiment with list re-ordering.
1) Generate a GPM Inter candidate list (405) and a GPM intra modes list (410)
2) Compute inter and intra template costs (415, 420), and based on these costs assign IPM indices to the lower GPM merge indices and inter candidate indices to the higher indices, or vice versa.
3) Finally, use the computed template costs for jointly re-ordering (425) both the GPM inter candidate and the IPM lists. Note that both the lists can be interleaved as well, based on the costs.

In embodiments, common cost metrics for Intra and Inter templates can be based on spatial domain or frequency domain metrics, such sum of absolute differences (SAD), sum of absolute transformed differences (SATD), variance, Sum of mean removed absolute differences (MAD), and the like.

### Partition Dependent Template Size

Motivation: In ECM 4.0, in template matching, the template being used is always either a Wx4 chunk from the top or a 4xH chunk from the left or both, where W and H denote width and height of a CU respectively. The TM complexity can be reduced if the template size is also defined as a function of the partition type. For example, in FIG. 3, each partition in the CU can use only pixels immediately adjacent to it from the top and from the left for constructing its template. Partition0, shaded gray, can only use neighboring pixels colored gray (305) for constructing its template. Similarly, Partition1, in white, can only use neighboring pixels colored white (310) for constructing its template.

### Proposal:

1) For partitions that are adjacent to either the left or the top border, use only neighboring reconstruction pixels that lie along this common boundary for constructing the template. For partitions that don't share any pixel with either the top or the left CU, reuse the entire template.

### REFERENCES

Each one of the references listed herein is incorporated by reference in its entirety. The term JVET refers to the Joint Video Experts Team of ITU-T SG 16 WP 3 and ISO/IEC JTC 1/SC 29.
[1]“Versatile Video Coding,” Rec. ITU-T H.266, August 2020.
[2] JVET-W0088, “EE2-3.3: GPM with MMVD (JVET-V0103 and JVET-V0125),” Z. Deng et al., teleconference, July 2021.
[3] JVET-W0065, “EE2: Results of Test 3.4 and Test 3.5,” R. -L. Liao et al., teleconference, July 2021.
[4] JVET-Y0065, “EE2-3.1: GPM with inter and intra prediction (JVET-X0166),” Y. Kidani et al., teleconference, January 2022.
[5] JVET-Y0067, “EE2-3.9 and EE2-3.10: TM based reordering for MMVD and affine MMVD and MVD sign prediction,” M. Salehifar et al., teleconference, January 2022.
[6] JVET-W0090: “EE2-3.1/EE2-3.2: Adaptive Reordering of Merge Candidates with Template/Bilateral Matching,” N. Zhang et al., teleconference, July 2021.
[7] JVET-W0097, “EE2-related: Combination of EE2-3.3, EE2-3.4 and EE2-3.5,” Xiaoyu Xiu et al., teleconference, July 2021.
[8] JVET-Z0124, “Non-EE2: Spatial GPM,” Fan Wang et al., teleconference, April 2022.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to applying geometric partitioning mode in image and video coding, such as those described herein. The computer and/or IC may compute any of a variety of parameters or values that relate to applying geometric partitioning mode in image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to applying geometric partitioning mode in image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### Equivalents, Extensions, Alternatives and Miscellaneous

Example embodiments that relate to applying geometric partitioning mode in image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method to derive geometric partitioning mode (GPM) inter candidate lists, the method comprising:
constructing a merge candidates list;
applying adaptive reordering of the merge candidates with template matching (ARMC-TM) to generate an ARMC-TM output;
applying parity-based ordering to the ARMC-TM output to generate a parity-based reordering;
generating GPM inter-candidates lists based on the parity-based reordering; and
generate partition0 and partition1 lists based on the GPM inter-candidates lists.

2. A method to derive geometric partitioning mode (GPM) inter candidate lists, the method comprising:
constructing a merge candidates list;
generating a partition0 template and a partition1 template;
for each of the partition0 or partition1 template:
applying adaptive reordering of the merge candidates with template matching (ARMC-TM) to generate an ARMC-TM output;
applying parity-based ordering to the ARMC-TM output to generate a parity-based reordering;
generating GPM inter-candidates lists based on the parity-based reordering; and
generate a partition list based on the GPM inter-candidates lists.

3. A method to derive geometric partitioning mode (GPM) inter candidate lists, the method comprising:
constructing a merge candidates list;
applying adaptive reordering of the merge candidates with template matching (ARMC-TM) to generate an ARMC-TM output;
generating GPM inter-candidates lists based on the ARMC-TM output; and
generate partition0 and partition1 lists based on the GPM inter-candidates lists.

4. A method to derive geometric partitioning mode (GPM) inter candidate lists, the method comprising:
constructing a merge candidates list;
generating a partition0 template and a partition1 template;
for each of the partition0 or partition1 template:
applying adaptive reordering of the merge candidates with template matching (ARMC-TM) to generate an ARMC-TM output;
generating GPM inter-candidates lists based on the ARMC-TM output; and
generate a partition list based on the GPM inter-candidates lists.

5. A method for signaling intra prediction modes (IPM) in geometric partitioning mode when both partitions are marked as intra, the method comprising:
signaling an all intra GPM enabled flag; and if the signaling all intra GPM enabled flag is set to enable, then signaling intra-level syntax elements for each partition.

6. The method of claim 5, wherein one signals a gpm_part_type_idx but not signals related to
IPM modes.

7. The method of claim 6, wherein the IPM modes are decided based on template matching.

8. A method to combine GPM and IPM lists, the method comprising:
generating a GPM Inter candidate list (405) and a GPM intra modes list (410)
compute inter template costs based on the generated GPM Inter candidate list;
compute intra template costs based on the generated GPM intra modes list;
assigning based on the computed inter template costs and the intra template costs IPM indices to the lower GPM merge indices and inter candidate indices to the higher indices;
applying the computed inter template costs and the intra template costs to and intra template costs (415, 420), and based on these costs assign IPM indices to the lower GPM merge indices and inter candidate indices to the higher indices, or vice versa;
and jointly re-ordering (425) both the GPM inter candidate and the IPM lists.

9. A method of template matching for coding units (CU) divided using a GPM mode, the method comprising:
given two partitions in a current CU,
when partition0 and partition1 share any pixels with either the top CU of the current CU or the left CU of the current CU, then, in template matching:
partition0 can use a template using only its immediate neighbor left or top pixels without using any pixels that are immediate neighbors of the partition1; and
partition1 can use a template using only its immediate neighbor left or top pixels without using any pixels that are immediate neighbors of the partition0.

10. A method to derive a geometric partitioning mode (GPM) intra candidate list, the method comprising:
accessing a coded unit (CU) with a top edge and a left edge;
applying a filter along the x axis of neighbor pixels, above the top edge of the CU, and along the y axis of neighbor pixels, left of the left edge of the CU, to generate G(x) and G(y) gradients for each (x,y) position of the center of the filter;
determining position information for a top intercept on the top edge of the CU and a left intercept on the left edge of the CU according to an edge detection criterion and the G(x) and G(y) gradients;
determining angle information for the top intercept and the left intercept based on the G(x) and G(y) gradients corresponding to the top intercept and the left intercept; and
determining the GPM candidate list based on the position and angle information for the top intercept and the left intercept.

11. The method of claim 10, wherein computing the gradients G(x) and G(y) comprises computing
$$G ( x ) = {F}_{x} * NbrRecon ( x , y ) ,$$
$$G ( y ) = {F}_{y} * NbrRecon ( x , y ) ,$$
wherein Fₓ and F_{y} denote edge filter kernels in the horizontal and vertical direction and NbrRecon(x, y) denotes a set of neighboring reconstructed pixels above the top edge or left of the left edge of the CU.

12. The method of claim 10, wherein the edge detection criterion comprises maximizing an L1-norm: |G(x)|+|G(y)| or an L2-norm \sqrt{G(x)²+G(y)²}.

13. The method of claim 10, wherein determining angle information at an intercept located at the filter position (x,y) comprises computing atan(G(y)/G(x)).

14. The method of claim 10, wherein determining the GPM candidate list based on the position and angle information for the top intercept and the left intercept comprises:
computing a reference mode partition that is closest to the top and left intercepts; and
determining the GPM candidate list by one or more of:
characterizing the reference mode partition using a pair (α, φ, where a is an angle index and p is a distance offset, and adding to the GPM candidate list partitions corresponding to the pairs (α−1, ρ), (α+1, ρ), (α, ρ−1), and (α, ρ+1);
characterizing the reference mode partition using the pairs (α_{L}, x_{L}) and (α_{T}, x_{T}), where α denotes an angle index and x denotes intercept position for the left and top intercepts, and adding to the GPM candidate list partitions corresponding to the pairs (α_{L}−1, x_{L}), (α_{L}+1, x_{L}), (α_{T}−1, x_{T}), and (α_{T}+1, x_{T});
characterizing the reference mode partition by its angle φ and adding to the GPM candidate list a mirror partition at an angle φ+180 degrees.

15. A non-transitory computer-readable storage medium having stored thereon computer-executable instructions for executing with one or more processors a method in accordance with claim 1.

16. An apparatus comprising a processor and configured to perform the method recited in claim 1.
